(19) United States
(12) Patent Application Publication
(10) Pub. No.: US 2021/0187737 A1
(43) Pub. Date: Jun. 24, 2021

(54) ROBOT CONTROL APPARATUS, ROBOT CONTROL METHOD, AND NON-TRANSITORY COMPUTER-READABLE STORAGE MEDIUM FOR CAUSING ONE OR MORE ROBOTS TO PERFORM A PREDETERMINED TASK FORMED BY A PLURALITY OF TASK PROCESSES

(71) Applicant: HONDA MOTOR CO., LTD., Tokyo (JP)

(72) Inventors: Gakuyo FUJIMOTO, Wako-shi (JP); Misako YOSHIMURA, Wako-shi (JP)

(21) Appl. No.: 17/106,393

(22) Filed: Nov. 30, 2020

(30) Foreign Application Priority Data
Dec. 19, 2019 (JP) 2019-229324

(51) Int. Cl. B25J 9/16

(52) U.S. Cl. CPC B25J 9/1661; B25J 9/163

(57) ABSTRACT

A robot control apparatus causes one or more robots to perform a predetermined task formed by a plurality of task processes. The robot control apparatus includes first control units each configured to control an operation of the one or more robots for each task process of the plurality of task processes, and a second control unit configured to specify a combination and an order to execute the first control units in the plurality of task processes and cause each of the first control units to operate in accordance with the combination and the order.

### CROSS-REFERENCE TO RELATED APPLICATION(S)

This application claims priority to and the benefit of Japanese Patent Application No. 2019-229324 filed on Dec. 19, 2019, the entire disclosure of which is incorporated herein by reference.

### BACKGROUND OF THE INVENTION

### Field of the Invention

The present invention relates to a robot control apparatus, a robot control method, and a non-transitory computer-readable storage medium for causing one or more robots to perform a predetermined task formed by a plurality of task processes.

### Description of the Related Art

In recent years, there is known a technique (International Publication No. 2004/033159) that applies a machine learning technique, for example, a neural network or the like to robot control operations in which a robot performs complex tasks such as walking and grasping a specific object. Although walking and grasping are complex tasks, each of them can be regarded as a single task. However, among tasks performed by people, there is a task that implements a single goal by a plurality of processes formed by combining tasks such as grasping and moving an object. Hence, there is a search for a technique that can effectively implement a complex task which can implement a single goal by performing a plurality of processes in robot control.

In order to use robot control to implement a task that is formed by a plurality of processes, it is possible to consider, as a method for implementing the above-described control, a method in which a task is broken down into task processes by a person in advance and a neural network specialized for each task process is set in advance by human labor. However, if the number of processes increases or if the combination becomes complex due to an increase in the number of selectable processes, it will become difficult to set the task processes by human labor in advance.

### SUMMARY OF THE INVENTION

In consideration of the above problem, a purpose of the present invention is to provide a technique that can set, without human labor, a combination of units that can execute processes in a case where a task which is formed by combining individual processes is to be executed by a robot.

In order to solve the aforementioned problems, one aspect of the present disclosure provides a robot control apparatus that causes one or more robots to perform a predetermined task formed by a plurality of task processes, comprising: one or more processors; and a memory storing instructions which, when the instructions are executed by the one or more processors, cause the robot control apparatus to function as: first control units each configured to control an operation of the one or more robots for each task process of the plurality of task processes; and a second control unit configured to specify a combination and an order to execute the first control units in the plurality of task processes and cause each of the first control units to operate in accordance with the combination and the order.

Another aspect of the present disclosure provides, a robot controlling method that is executed by a robot control apparatus for one or more robots to perform a predetermined task formed by a plurality of task processes, the method comprising: causing each of first control units to control an operation of the one or more robots for each task process of the plurality of task processes; and causing a second control unit to specify a combination and an order to execute the first control units in the plurality of task processes and to cause each of the first control units to operate in accordance with the combination and the order.

Still another aspect of the present disclosure provides, a non-transitory computer-readable storage medium storing a program to cause a computer to function as each unit of a robot control apparatus, wherein the robot control apparatus is a robot control apparatus which causes one or more robots to perform a predetermined task formed by a plurality of task processes, and comprises first control units each configured to control an operation of the one or more robots for each task process of the plurality of task processes, and a second control unit configured to specify a combination and an order to execute the first control units in the plurality of task processes and cause each of the first control units to operate in accordance with the combination and the order.

According to the present invention, in a case where a task which is formed by combining individual processes is to be executed by a robot, a combination of units that can execute the processes can be set without human labor.

### BRIEF DESCRIPTION OF THE DRAWINGS

FIG. 1 is a block diagram showing an example of the functional arrangement of a robot control apparatus according to an embodiment of the present invention;

FIG. 2 is a view for explaining an example of the arrangement for robot control processing according to the embodiment;

FIG. 3 is a view for explaining an example of the arrangement of a single learning model for the robot control processing according to the embodiment;

FIG. 4 is a view for explaining an example of task process learning in robot control according to the embodiment;

FIG. 5 is a first view for explaining an example of a learning model corresponding to the task process according to the embodiment;

FIG. 6 is a second view for explaining an example of the learning model corresponding to the task process according to the embodiment;

FIG. 7 is a flowchart showing a series of operations of the robot control processing during a learning stage according to the embodiment;

FIG. 8 is a flowchart showing a control operation of a lower-layer model of the learning stage according to the embodiment; and

FIG. 9 is a flowchart showing a series of operations of robot control processing of a learned stage according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Arrangement of Robot Control Apparatus>

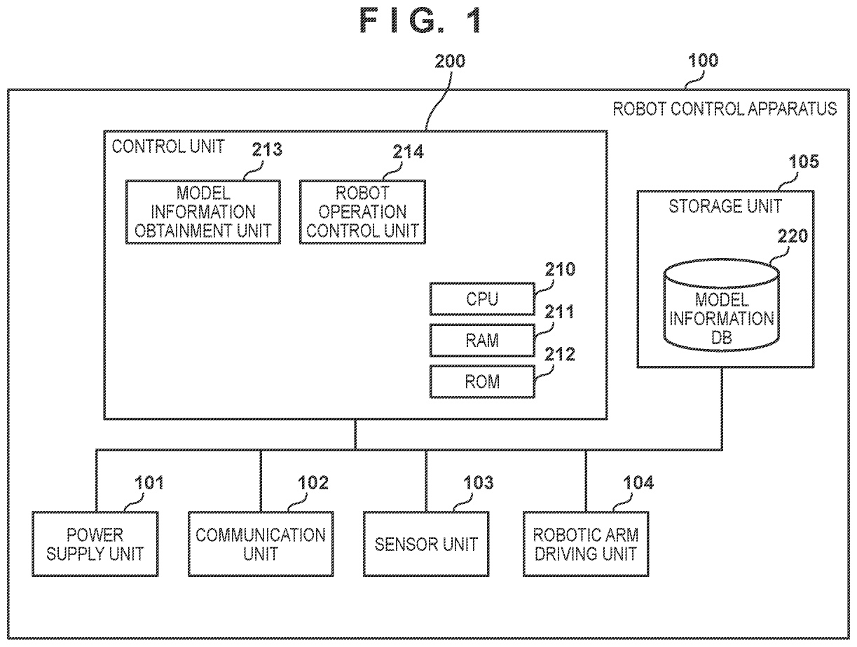

An example of the functional arrangement of a robot control apparatus 100 according to an embodiment will be described next with reference to FIG. 1. Note that functional blocks to be described with reference to the following drawings may be integrated or separated, and a function to be explained may be implemented by another block. In addition, a function described as hardware may be implemented by software, and vice versa.

A power supply unit 101 includes a battery formed by, for example, a lithium ion battery or the like, and supplies power to each unit in the robot control apparatus 100. A communication unit 102 is, for example, a communication device including a communication circuit and the like, and communicates with an external server via, for example, WiFi communication, LTE-Advanced, mobile communication in accordance with the so-called 5G standard, or the like. For example, in a case where model information (to be described later) has been updated or the like, the latest model information may be obtained from an external server.

A sensor unit 103 includes various kinds of sensors that measure the operation and posture of a manipulator of a robotic arm (not shown) which is to be controlled by the robot control apparatus 100. The robotic arm includes, for example, a plurality of fingers for grasping an object and an articulated arm for shaking and moving the grasped object, and is integrally formed with the robot control apparatus 100. There may not only be a single robotic arm, but a plurality of robotic arms. A known robotic arm that can, for example, grasp, shake, and move an ingredient, cooking utensil, a condiment, or the like can be used as a robotic arm according to this embodiment.

The various kinds of sensors include, for example, sensors that measure the angle of each joint of the robotic arm and the acceleration of each finger and the arm. In addition, the various kinds of sensors also include an imaging sensor that captures the posture of the robotic arm (from a plurality of directions) and an imaging sensor that captures the position and the state of an object handled by the robotic arm (from a plurality of directions), and the sensor unit 103 outputs the captured image information.

A robotic arm driving unit 104 includes a manipulator that drives the operation of the arm and each finger of one or more robotic arms. The robotic arm driving unit 104 can drive each of the one or more robotic arms independently. Although a case where a robotic arm (and the robotic arm driving unit 104 and the sensors related to the robotic arm) is included in the robot control apparatus 100 will be exemplified in this embodiment, the robotic arm may also be arranged separately from the robot control apparatus 100.

A storage unit 105 is a large-capacity non-volatile storage device such as a semiconductor memory or the like, and temporarily or permanently stores the sensor data collected by the sensor unit 103. The storage unit 105 includes a model information DB 220 which includes respective pieces of learning model information of a plurality of reinforcement learning models (to be described later). Each piece of learning model information includes, for example, program codes of a learning model, learned parameter information, information of a layer structure in which each reinforcement model is positioned. Note that this embodiment will exemplify a case where the learned parameter information points to the value of a weighting parameter between neurons of a neural network. However, in a case where another machine learning model is to be used, the value of a parameter corresponding to this learning model may be used.

Each reinforcement learning model includes a reinforcement learning model for controlling the operations of the robotic arm and an upper-layer reinforcement learning model for controlling the execution of a plurality of lower-layer reinforcement learning models. Each of the lower-layer reinforcement learning models causes the robotic arm to perform a single task such as grasping and moving an object, for example, “grasping an egg”, “cracking the eggshell”, “sprinkling salt”, “pouring oil into a frying pan”, or the like.

A control unit 200 includes, for example, a CPU 210, a RAM 211, and a ROM 212, and controls the operation of each unit of the robot control apparatus 100. The control unit 200 executes, based on the sensor data from the sensor unit 103 and the learning model information, processing of a learning stage and processing of a learned stage of robot control processing. In the control unit 200, the CPU 210 causes a computer program stored in the ROM 212 to be loaded into the RAM 211 and executes the loaded program to cause each unit in the control unit 200 to execute its function.

The CPU 210 includes one or more processors. The RAM 211 includes, for example, a DRAM or the like, and functions as a work memory of the CPU 210. The ROM 212 is formed by a non-volatile storage medium, and stores computer programs to be executed by the CPU 210, setting values to be used to operate the control unit 200, and the like. Note that although the following embodiment will exemplify a case where the CPU 210 is to execute the processing of a robot operation control unit 214, the processing of the robot operation control unit 214 may be executed by one or more other processors (for example, a GPU) (not shown).

A model information obtainment unit 213 obtains, from the pieces of learning model information stored in the storage unit 105, the learning model information of each layer necessary for the operation of the robotic arm, and supplies the obtained information to the robot operation control unit 214. The learning model information of each layer is specified when an upper-layer reinforcement learning model has been learned, and is stored in the storage unit 105.

The robot operation control unit 214 controls the operation of the robotic arm by performing arithmetic processing of, for example, a machine learning algorithm (reinforcement learning model) such as deep reinforcement learning or the like and outputting a control variable to the robotic arm driving unit 104. Also, in relation to each of a plurality of reinforcement learning algorithms that have a layer structure, the robot operation control unit 214 executes, for example, an upper-layer reinforcement learning algorithm to execute a plurality of lower-layer reinforcement learning algorithms in a suitable combination and order. As a result, it will be possible to cause the robotic arm to execute a series of tasks formed by a plurality of processes. In the processing of the learning stage, the robot operation control unit 214 learns the combination and the execution order of the lower-layer reinforcement learning algorithms through trial and error.

<Outline of Robot Control Processing Using Hierarchical Reinforcement Learning Model>

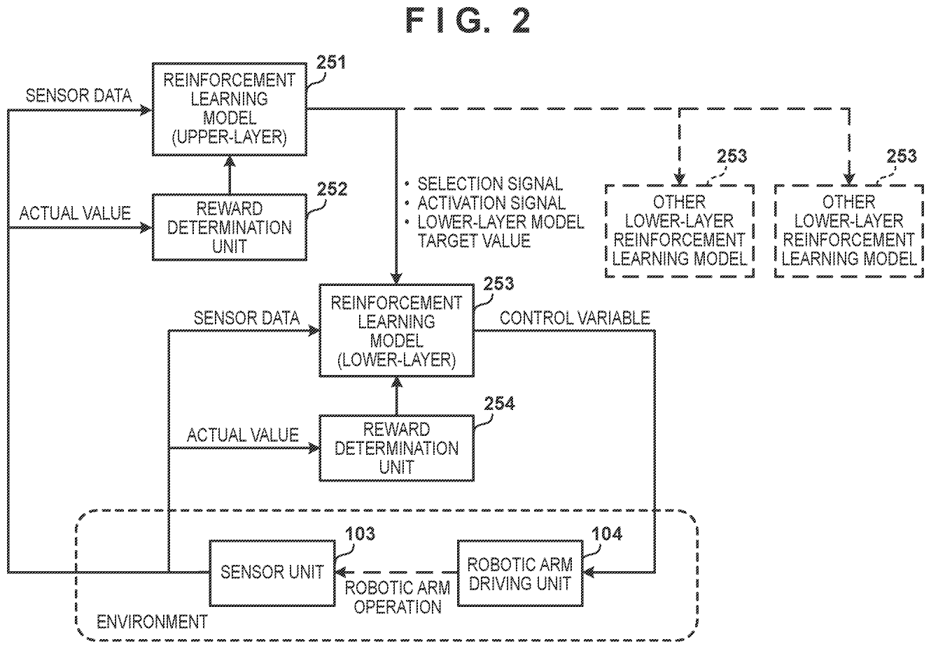

The outline of robot control processing using a hierarchical reinforcement learning model will be described next with reference to FIG. 2.

In this robot control processing model, an upper-layer reinforcement learning model will select a reinforcement learning model to be executed from lower-layer reinforcement learning models to control the operation of the robotic arm by activating the reinforcement learning model to be executed at a suitable timing.

The example of FIG. 2, for example, shows an arrangement in which an upper-layer reinforcement learning model 251 is executed to control the execution of one or more reinforcement learning models (for example, reinforcement learning models 253) which belong to a layer which is one layer or more lower than the upper-layer reinforcement learning model.

The reinforcement learning model 251 provides a selection signal to one lower-layer reinforcement learning model 253 to select a plurality of reinforcement learning models. When the selected lower-layer reinforcement learning model has been activated (that is, the robotic arm has been operated) and the execution of this selected reinforcement learning model 253 has been completed (that is, inactivated), another reinforcement learning model 253 is activated. In this manner, a series of robotic arm operations including a plurality of tasks can be controlled by combining lower-layer reinforcement learning models which are each used to execute one task of the robotic arm.

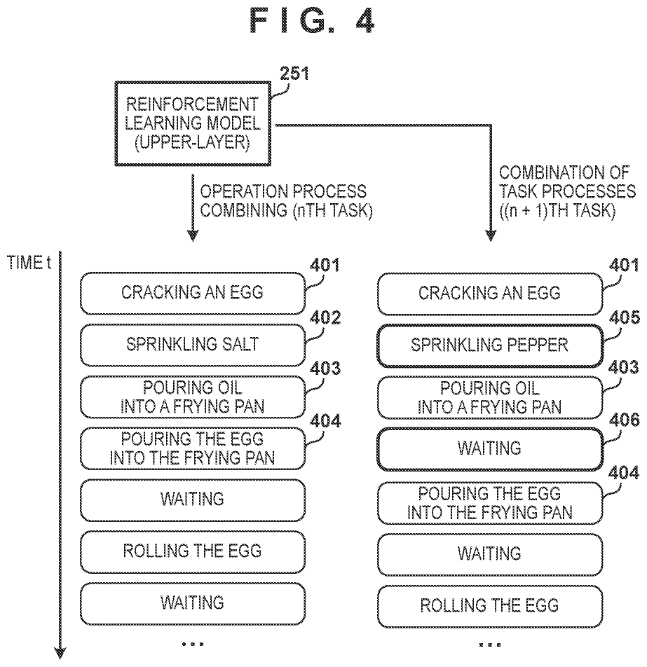

The reinforcement learning model 251 belonging to the upper layer controls, for example, as shown in FIG. 4, the combination and the order of tasks to be executed by the lower-layer reinforcement learning models 253. For example, the reinforcement learning model 251 is a reinforcement learning model that causes the robotic arm to execute a task of “cooking a rolled omelet” which includes a plurality of tasks. Each of the lower-layer reinforcement learning models causes the robotic arm to execute a corresponding one of individual tasks such as a task 401 of “cracking an egg”, a task 402 of “sprinkling salt”, a task 403 of “pouring oil into a frying pan”, a task 404 of “pouring the egg into the frying pan”, and the like.

The example shown in FIG. 4 shows the process in which the reinforcement learning model 251 learns the task of “cooking a rolled omelet” by using reinforcement learning. For example, in the nth operation of the task, the robotic arm is made to sequentially execute the task 401 of “cracking an egg”, the task 402 of “sprinkling salt”, the task 403 of “pouring oil into a frying pan”, the task 404 of “pouring the egg into the frying pan”, and the like (based on the lower-layer reinforcement learning models). In each of the tasks 401 to 404 and the like, a corresponding lower-layer reinforcement learning model causes the robotic arm to perform the corresponding task. When the series of plurality of lower-layer operations (to be also referred to as episodes) executed by the reinforcement learning model 251 has been completed, a reward determination unit 252 outputs a reward to be provided to the reinforcement learning algorithm based on the difference between a target value and a state (an actual value) of an environment obtained as an execution result.

The reinforcement learning model 251 obtains, for example, the image information of a cooked rolled omelet as the target value of the rolled omelet cooking task from an even upper layer reinforcement learning model. The image information to be the target value may be, for example, an image that has been captured in advance, and the reinforcement learning model 251 may correct, based on the environment, the brightness and the color of the image obtained from the model information DB 220.

The reward determination unit 252 is a module that provides a reward to the reinforcement learning model 251, and obtains, as the actual value, the image information of the rolled omelet obtained as a result of controlling the lower-layer reinforcement learning models. The reward determination unit 252 determines, based on the difference between the target value and the actual value, the reward to be given to the reinforcement learning model 251. For example, the reward determination unit 252 inputs a reward corresponding to the difference into the reinforcement learning model 251 based on a difference (for example, the color, the shape, the size, or the like of the rolled omelet) between the image of the rolled omelet set as the target value and the image of the rolled omelet set as the actual value.

The reinforcement learning model 251 corrects the parameters of a policy to be used in the reinforcement learning model based on, for example, the reward (the reward based on the difference between the target value and the actual value) output from the reward determination unit 252. Based on this correction, a task 405 of “sprinkling pepper” has been set to be performed after the task 401 of “cracking an egg” in the (n+1)th task. In addition, a task 406 of “waiting” has been set to be executed after the task 403 of “pouring oil into a frying pan”, and the task 404 of “pouring the egg into the frying pan” has been set to be executed thereafter. In this manner, the reinforcement learning model 251 learns the optimal task process by learning the combinations of lower-layer reinforcement learning models through trial and error.

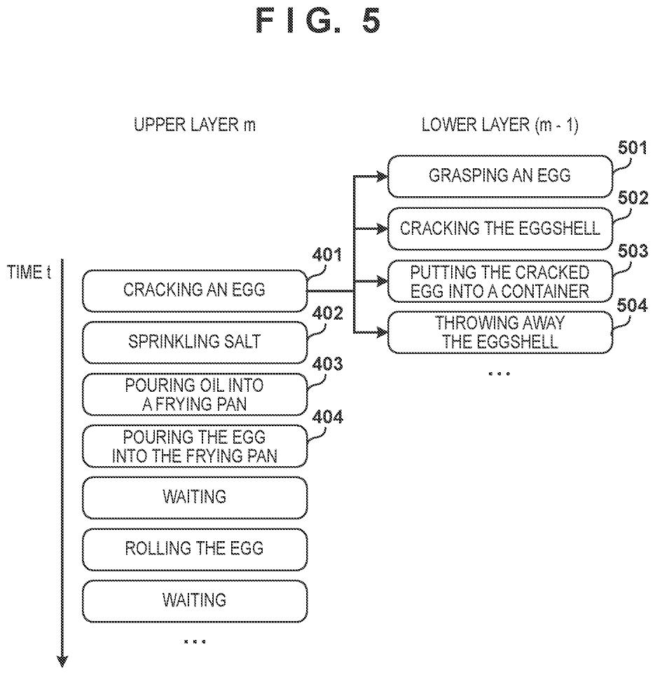

FIG. 5 shows an example of the relationship between an upper-layer learning model and lower-layer learning models. For example, the task 401 of “cracking an egg” of an upper layer m is implemented by causing the reinforcement learning models, of a lower layer m−1, such as a task 501 of “grasping an egg”, a task 502 of “cracking the eggshell”, a task 503 of “putting the cracked egg into a container”, and the like to operate. Although it is not illustrated in FIG. 5, each of the task 402 of “sprinkling salt”, the task 403 of “pouring oil into a frying pan”, and the like is associated with corresponding lower-layer reinforcement learning models to execute the task. In this manner, the lower-layer tasks are executed to execute the tasks 401 to 404 and the like which are to be used in the upper layer. For example, in a case where the lower layer m−1 is the lowest layer, the reinforcement learning models will be formed to control the robotic arm.

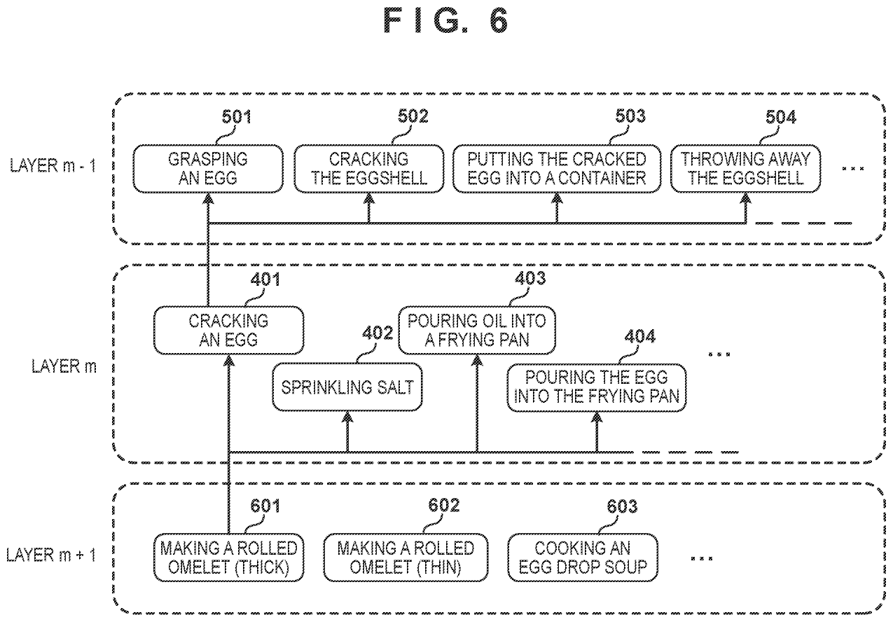

The hierarchical relationship of the reinforcement learning models can be predetermined, for example, as shown in FIG. 6, and can be included in the model information DB as information of the hierarchical structure in which the reinforcement learning models are positioned. For example, the reinforcement learning models such as the task 501 of “grasping an egg”, the task 502 of “cracking the eggshell”, the task 503 of “putting the cracked egg into a container”, and the like described above can be positioned at a layer lower than the layer of the reinforcement learning model for the task 401 of “cracking an egg”. Also, models for tasks (for example, the task of cooking a rolled omelet) with longer processes including the task of “cracking an egg” are positioned in a layer m+1 which is an upper layer. For example, each of the models for a task 601 of “cooking a rolled omelet (thick)”, a task 602 of “cooking a rolled omelet (thin)”, and a task 603 of “cooking an egg drop soup” is a model which belongs to a layer further above and includes the model for the task 401 of “cracking an egg”.

For example, in a case where a user instructs the robot control apparatus 100 to perform the task of “cooking a rolled omelet (thick)”, a plurality of reinforcement learning models of the layer m are selected as the reinforcement learning models related to the task 601 of “cooking a rolled omelet (thick)”. Subsequently, the selected reinforcement learning models of the layer m are sequentially activated/inactivated based on the learned combination and order to cause the robotic arm to execute the task 401 of “cracking an egg”, the task 402 of “sprinkling salt”, and the like. When the reinforcement learning model of the task 401 of “cracking an egg” is activated, it will cause models of a layer further below to control the robotic arm to perform a series of operations such as grasping an egg, cracking the eggshell, and the like.

The information of the reinforcement learning models of each layer stored in the model information DB 220 includes, for example, program codes and learned parameters as the learned reinforcement learning models obtained by completing the learning by reinforcement learning. The learning of each reinforcement learning model may be completed in the actual environment using the robotic arm or may be set to a completed state by executing a simulation in an external information processing server. If the learned lower-layer learning models are stored in the model information DB, each upper-layer reinforcement learning model can advance the learning by using the learned lower-layer models. Hence, the learning efficiency can be greatly improved compared to a case where the models of all of the layers are learned. Since each reinforcement learning model can autonomously specify the lower-layer reinforcement learning models to be used by repeatedly exploring and exploiting the respective lower-layer reinforcement models during learning, the lower-layer models need not be set by human labor.

Referring back to FIG. 2, each lower-layer reinforcement learning model 253 performs control by outputting a control variable to the robotic arm driving unit 104 to cause the robotic arm to, for example, grasp and move an object. That is, in the example of the task 501 of “grasping an egg” shown in FIG. 5, the corresponding reinforcement learning model 253 will (use the robotic arm driving unit 104 to) control the robotic arm to cause the robotic arm to grasp the eggs.

When the robotic arm operates, the sensor unit 103 will obtain the joint angle and the acceleration speed, or an image capturing the orientation of the robotic arm, an image capturing the posture of an object (for example, an egg), and the like to obtain feedback from the environment. The feedback obtained from the environment at the timing in which control corresponding to a single episode (to be described later) has been performed is also used as an actual value to calculate the reward by a reward determination unit 254.

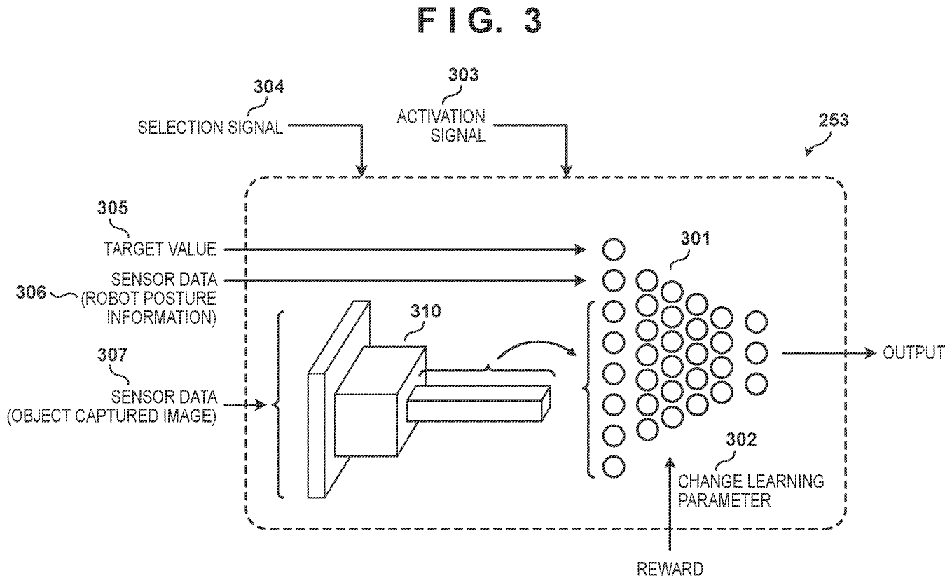

A more detailed arrangement example of each reinforcement learning model 253 will be described further with reference to FIG. 3. Note that although the output format (that is, the arrangement of a neural network related to the output) may be different from the output format of an upper layer reinforcement learning model, the input signals to be input to the reinforcement learning model 253 and the arrangement of the neural network other than the output layer may be similar to those of the upper-layer reinforcement learning model.

When the reinforcement learning model 253 is selected by a selection signal 304 from the upper-layer reinforcement learning model 251, the reinforcement learning model 253 according to this embodiment is read out from the model information DB of the storage unit 105. The reinforcement learning model 253 is set in a state to wait to be used by the upper layer, reinforcement learning model 251, that is, the reinforcement learning model 253 will be set in an inactive state.

Also, while an activation signal in which an activation flag from the reinforcement learning model 251 is set to 1 is being input, the reinforcement learning model 253 will be set in an active state, perform arithmetic processing by the neural network, and output information. When the activation flag is set to 0 again, the reinforcement learning model 253 will be set in an inactive state, and neither the arithmetic processing of the neural network nor the output of the output information will be performed.

The reinforcement learning model 253 will further obtain, as an input, a target value 305 from the upper-layer reinforcement learning model 251. As described above, the target value 305 is, for example, image information that represents the target value to be obtained when the corresponding reinforcement learning model is executed.

The reinforcement learning model 253 receives the target value 305, sensor data (posture information) 306, and sensor data (object captured image) 307 and performs arithmetic processing using a neural network 310 and a neural network 301. In a case where the reinforcement learning model 253 is a model that directly controls the robotic arm driving unit 104, a control variable for controlling the robotic arm driving unit 104 is output as the arithmetic processing result of the neural network. On the other hand, in a case where the reinforcement learning model 253 is a model that does not directly control the robotic arm driving unit 104, a selection signal, an activation signal, and a target value for controlling the corresponding lower-layer model will be output.

The neural network 301 is a neural network that outputs a reinforcement learning model policy in accordance with the input. On the other hand, the neural network 310 has, for example, a network structure such as CNN (Convolutional Neural Network) or the like. For example, by performing convolution processing and pooling processing in stages on an input image, a superior feature amount of the image information can be extracted, and the extracted feature amount is input to the neural network 301.

The sensor data 306 and 307 correspond to a state sₜ of an environment in reinforcement learning, and a control variable (or the selection signal, the activation signal, and the target value) corresponds to an action at toward the environment. Also, when the action at is executed by the robotic arm driving unit 104, the sensor unit 103 will obtain the sensor data at time t+1 and output the obtained data to the control unit 200. In reinforcement learning, this new sensor data corresponds to a state sₜ₊₁.

In the learning stage, the reinforcement learning model 253 inputs a reward that can be obtained from the difference between the actual value and the target value described above for each episode (which is a series of operations performed by the reinforcement learning model 253 to achieve an object, for example, “grasping an egg” and the like). Depending on the input reward, for example, a weighting parameter of neurons forming the neural network 301 is changed by backpropagation.

<Series of Operations Related to Robot Control Processing in Learning Stage>

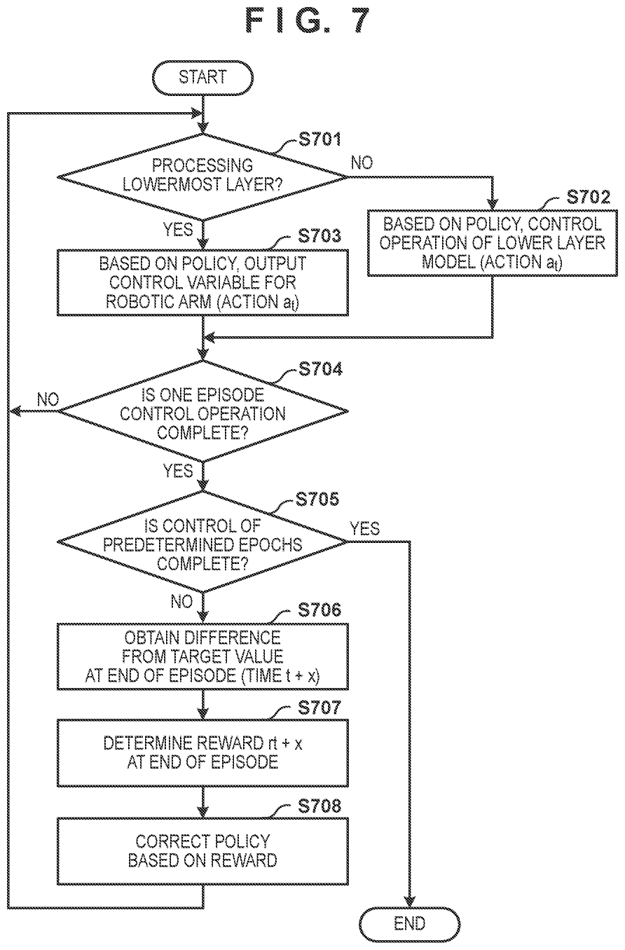

A series of operations of robot control processing of the robot control apparatus 100 will be described next with reference to FIG. 7. This processing shows the processing performed in the learning stage of one reinforcement learning model of a given layer. Note that the processing performed by components such as the model information obtainment unit 213, the robot operation control unit 214, and the like in the control unit 200 is implemented by the CPU 210 loading a program stored in the ROM 212 to the RAM 211 and executing the program. Also, in the example according to this embodiment, assume that each operation performed in a layer lower than the layer of the reinforcement learning model which is set as the target of this processing is executed by a learned reinforcement learning model. Since learning by trial and error need not be performed in each lower-layer reinforcement learning model in this case, the learning of the upper-layer model can be performed efficiently and at high speed.

In step S701, the robot operation control unit 214 determines whether the target processing is processing by a lowest-layer reinforcement learning model. If the robot operation control unit 214 determines, based on the information of the hierarchical structure of the model information DB obtained by the model information obtainment unit 213, that the target processing is processing by the lowest-layer reinforcement learning model, the process advances to step S703. The lowest-layer reinforcement learning model is the most primitive reinforcement learning model for directly controlling the robotic arm and does not include other reinforcement learning models in a layer below. On the other hand, if the robot operation control unit 214 determines that the target processing is not processing by the lowest-layer reinforcement learning model, the process advances to step S702.

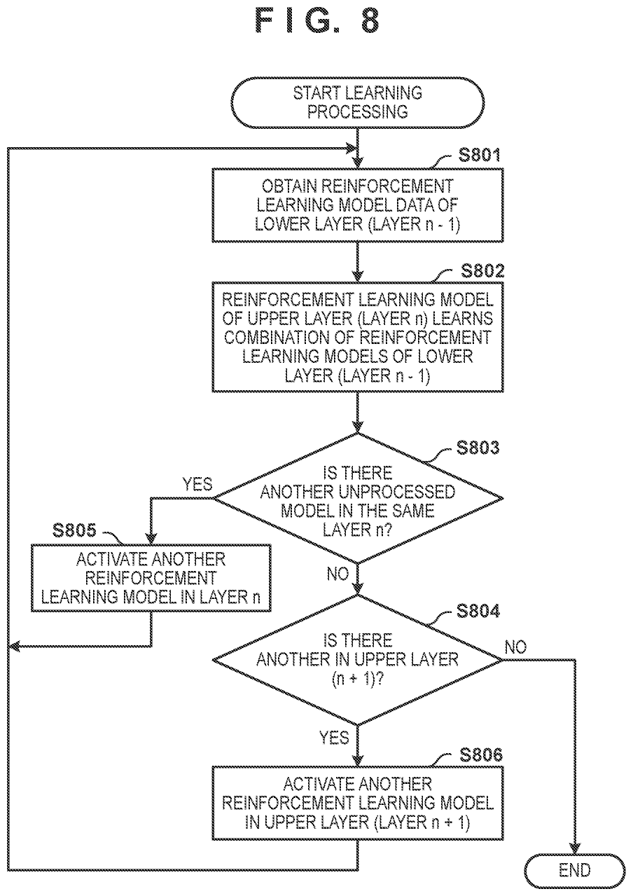

In step S702, the robot operation control unit 214 controls the operation of a lower-layer reinforcement learning model by outputting (that is, this corresponds to the action at) an activation signal or the like to the lower-layer reinforcement learning model based on the policy at that point of time. Note that the details of the processing for controlling the operation of the lower-layer reinforcement learning model will be described later with reference to FIG. 8. On the other hand, in step S703, since the target processing is processing by the lowest-layer reinforcement learning model, the robot operation control unit 214 will output (that is, this corresponds to the action at) control variable to the robotic arm based on the policy at that point of time.

In step S704, the robot operation control unit 214 determines whether a control operation of one episode has been completed. For example, in the case of the task 401 of “cracking an egg”, the control operation of one episode will be determined to have completed when the tasks from the task 501 of “grasping an egg” to, for example, a task 504 of “throwing away the eggshell” have been completed. That is, the robot operation control unit 214 will determine that the control operation of one episode has been completed in a case where all of the operations performed by the selected reinforcement learning model have completed. If the robot operation control unit 214 determines that the control operation of one episode has not been completed, the process returns to step S701 to repeat the process until the control operation of the episode is completed. On the other hand, if it is determined that the control operation of the one episode has been completed, the process advances to step S705.

In step S705, the robot operation control unit 214 determines whether a predetermined number of epochs of the control operation has been completed. A predetermined number of epochs is a hyperparameter that determines how many times the control operation of one episode is to be repeated. The predetermined number of epochs is determined by an experiment or the like, is the operation count at which the weighting parameter of the neural network will sufficiently converge to an optimized value, and is set to a suitable value which will not cause overtraining. Since it can be determined that the processing of the learning stage has been completed if it is determined that the control operation has been repeated for the predetermined number of epochs, the robot operation control unit 214 will end this series of processing operations. On the other hand, if it is determined that the predetermined number of epochs of the control operation has not been completed, the process advances to step S706.

In step S706, the reward determination unit 252 (or the reward determination unit 254) of the robot operation control unit 214 will obtain, based on the sensor data output from the sensor unit 103, a difference between the target value and the actual value at the time (time t+x) of the end of the episode. As described above, the reward determination unit 252 or 254 will compare the image information provided as the target value and the image information obtained by capturing the object and the posture of the robot arm obtained from the sensor unit 103. At this time, the reward determination unit may not only simply compare the pieces of image information but also compare the obtained sensor data value with the target value upon recognizing the type, the posture, the color, and the size of the object in the image.

In step S707, the reward determination unit 252 (or the reward determination unit 254) calculates a reward rₜ₊ₓ based on the difference between the sensor data and the target value. For example, a reward can be set to increase as the difference between the target value and the sensor data (actual value) at time t+x decreases. An arbitrary method can be used as long as it is a method that determines the reward so as to minimize the difference between the target value and the actual value, and can be a known method.

In step S708, the robot operation control unit 214 changes the weighting parameter of the neural network (for example, the neural network 301) related to the policy used in the reinforcement learning model so that the reward will be maximized. Upon changing the weighting parameter of the neural network, the robot operation control unit 214 returns the process to step S701. In this manner, in the robot control processing shown in FIG. 7, a single reinforcement learning model according to this embodiment can advance the learning operation based on the difference between the target value and the actual value in the learning stage.

<Series of Operations Related to Control Processing of Lower-Layer Reinforcement Learning Models>

The control processing of a lower-layer reinforcement learning model corresponding to the above-described process of step S702 will be described in detail next with reference to FIG. 8. Note that this processing is implemented by the control unit 200 executing a program in a similar manner to the processing illustrated in FIG. 7. Also, this processing is processing that causes a reinforcement learning model of a layer higher than a layer n to perform learning.

In step S801, the robot operation control unit 214 uses the information of the hierarchical structure of the model information DB 220 to obtain the data of each reinforcement learning model of a layer (a layer n−1) lower than the processing target reinforcement learning model (of the layer n).

In step S802, the robot operation control unit 214 causes the reinforcement learning model of the upper layer (the layer n) to learn the combination of reinforcement learning models of the lower layer (the layer n−1). That is, the processing of this step corresponds to executing control processing on a combination of new task processes upon changing the combination of task processes exemplified in FIG. 4.

In step S803, the robot operation control unit 214 determines whether another unprocessed reinforcement learning model is present in the same layer n. An unprocessed reinforcement learning model points to, for example, a case where there is another reinforcement learning model (this corresponds to, for example, the task 402 of “sprinkling salt”) that has not output an action when the control operation by the reinforcement learning model related to the task 401 of “cracking an egg” has been performed in step S802 of the example shown in FIG. 5. If it is determined that another unprocessed reinforcement learning model is present in step S803, the robot operation control unit 214 advances the process to step S805. On the other hand, if it is determined that no other unprocessed reinforcement learning model is present in the same layer, the robot operation control unit 214 advances the process to step S804.

In step S804, the robot operation control unit 214 further determines whether a reinforcement learning model is present in a layer (a layer n+1) above the processing target layer. The robot operation control unit 214 uses the information of the hierarchical structure of the model information DB 220 to determine whether a reinforcement learning model is present in the layer further above. If it is determined that a reinforcement learning model is present in the layer further, the process advances to step S806. On the other hand, if it is determined that a reinforcement learning model is not present in a layer further above, it will be determined that the control operation of the final reinforcement learning model of the highest layer has been executed, and this series of processing operations will be ended (that is, returned to the caller).

In step S805, the robot operation control unit 214 activates the other reinforcement learning model of the layer n (by the upper-layer reinforcement learning model) and causes the processing to be repeated again from step S801 for this activated reinforcement learning model.

In step S806, the robot operation control unit 214 activates the reinforcement learning model of the layer (the layer n+1) further above, and causes the processing to be repeated again from step S801 for this activated reinforcement learning model.

In this manner, reinforcement learning model learning can be advanced for each layer by learning the combination of lower-layer reinforcement learning models while setting a reinforcement learning model of a layer further above as the learning target.

<Series of Operations Related to Control Processing of Learned Reinforcement Learning Models>

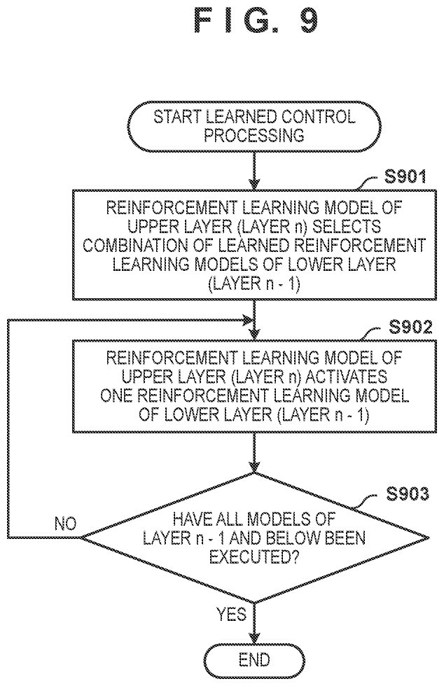

A series of operations related to the control processing of learned reinforcement learning models will be described next with reference to FIG. 9. Note that this processing is performed at a stage in which all of the reinforcement learning models have been learned, and is in a state (that is, in an optimized state with respect to the environment) where every combination of the lower-layer reinforcement learning models and the corresponding order in which the models are to be used with respect to a single reinforcement learning model of a given layer have been learned. In addition, this processing is started in a case where the user has selected a reinforcement learning model positioned at the highest layer and has issued an task start instruction. For example, in the above-described example, this processing corresponds to a case in which the user has selected the task 601 of “making a rolled omelet” in the layer m+1 and has issued a task start instruction.

Note that since the execution of the processing of the learning stage described in FIG. 7 is unnecessary in the learned stage, the parts related to the control processing of a layered-state reinforcement learning model will be described. Also, in a similar manner to the other processing operations, the processing shown in FIG. 9 is implemented by the control unit 200 loading a program into the RAM 211 and executing the program.

In step S901, the robot operation control unit 214 causes a reinforcement learning model of the upper layer (the layer n) to select a learned combination of the reinforcement learning models of the lower layer (the layer n−1). The robot operation control unit 214 will refer to, for example, the information of the layer structure stored in the model information DB 220 via the model information obtainment unit 213 and obtain the combination of lower-layer reinforcement learning models associated with the operation of a given reinforcement learning model.

In step S902, the robot operation control unit 214 executes the processing of the reinforcement learning model of the upper layer (the layer n) and causes the associated lower-layer reinforcement learning models to be sequentially (recursively) executed. Furthermore, in step S903, the robot operation control unit 214 determines whether all of the reinforcement learning models of the layer n−1 and layers below that are associated with the processing-target reinforcement learning model have been executed. If it is determined that all of the associated reinforcement learning models of the layer n−1 and layers below have been executed, the robot operation control unit 214 will end this processing. On the other hand, if it is determined that all of the associated reinforcement learning models of the layer n−1 and layers below have not been executed, the process will be returned to step S902 so that the process of step S902 can be repeated until the execution of all of the models has been completed.

As described above, in this embodiment, in the robot control apparatus 100 that causes one or more robots to execute a predetermined task formed by a plurality of task processes, a reinforcement learning model for controlling a robotic arm to perform the predetermined task is arranged to have a layered structure. It is also arranged so that a reinforcement learning model which is positioned in an upper layer can learn and specify the combination and the execution order of a plurality of reinforcement learning models which are positioned in a lower layer, and control the specified combination. By such an arrangement, it will be possible to determine the combination of units that can execute each process in a case where a task which is a combination of individual processes is to be executed by a robot.

In addition, setting an arrangement in which an upper-layer reinforcement learning model controls a combination of a plurality of lower-layer reinforcement learning models will allow the user to easily develop a new upper-layer reinforcement learning model. Also, since the upper-layer reinforcement learning model need not relearn the lower-layer reinforcement learning models as long as the lower-layer reinforcement learning models have been learned beforehand when the upper-layer reinforcement learning model is to perform learning, learning will be able to be advanced efficiently. Furthermore, since an upper-layer task can be implemented by arbitrarily selecting necessary models among various kinds of lower-layer reinforcement learning models, it will be possible to generate reinforcement learning models that can support various kinds of needs including niche needs.

Note that the above-described embodiment described an example of a mode in which a robotic arm is included in the robot control apparatus 100. However, the robot control apparatus 100 may be arranged separately from the robotic arm, and the robot control apparatus may operate as an information processing server to remotely control the robotic arm. In this case, the sensor unit 103 and the robotic arm driving unit 104 will be arranged outside the robot control apparatus. The robot control apparatus which is operating as the server will receive the sensor data from the sensor unit via a network. Subsequently, a control variable obtained by the robot operation control unit 214 will be transmitted to the robotic arm via the network.

In addition, although the above-described embodiment described an example of a case where the plurality of processes required for cooking a dish using an egg are to be implemented by controlling a robotic arm, the present invention is not limited to this example. Processes required for cooking a dish using another ingredient can be implemented by controlling the robot arm as a matter of course, and a plurality of process required for a task using other instruments can also be implemented by controlling the robotic arm.

For example, the present invention is also applicable to a case where tools of different sizes and shapes are used to fasten a bolt and to remove a nut from the bolt. In a case where a task including such a plurality of processes is to be performed, for example, different reinforcement learning models each used to hold a tool corresponding to the size and shape of the bolt and the nut, a reinforcement learning model for fastening the bolt or the nut by the held tool, a reinforcement learning model for performing a loosening task, and the like can be hierarchically combined, and the activation of these models can be controlled.

### SUMMARY OF EMBODIMENT

1. There is provided a robot control apparatus (for example, 100) of the above-described embodiment is a robot control apparatus that causes one or more robots to perform a predetermined task formed by a plurality of task processes, comprising:

first control units (for example, 214, 253) each configured to control an operation of the one or more robots for each task process of the plurality of task processes; and

a second control unit (for example, 214, 251) configured to specify a combination and an order to execute the first control units in the plurality of task processes and cause each of the first control units to operate in accordance with the combination and the order.

According to this embodiment, in a case where a task formed by combining individual processes is to be executed by a robot, the combination of units that can execute the processes can be set without human labor.

2. In the above-described embodiment, the apparatus further comprises

a third control unit (for example, 251) configured to specify a combination and an order to execute a plurality of the second control units (for example, 251) in the plurality of task processes and to cause each second control unit to operate in the specified combination and order to execute the second control unit.

According to this embodiment, since a control unit can be arranged hierarchically by setting an arrangement that includes a third control unit which is configured to further control the second control unit, it will be possible to implement various kinds of control units.

3. In the above-described embodiment, each of the first control unit and the second control unit is formed by a learning model (for example, 253, 251) using reinforcement learning.

According to this embodiment, even in the case of a task in which sufficient teaching data cannot be prepared to cause a model to learn, learning can be advanced through trial and error by using a learning model.

4. In the above described embodiment, the second control unit uses, when learning the combination and the order to execute the first control units, the learned first control units that have been learned in advance.

According to this embodiment, since learned models can be used as lower-layer learning models when learning is to be performed by an upper-layer learning model, the learning can be performed efficiently, and highly accurate learning can be performed because the learning of all of the models will not be performed simultaneously.

5. In the above-described embodiment, the second control unit controls the combination and the order to execute the first control units by outputting, from the learning model using the reinforcement learning, an activation signal which activates each of the plurality of first control units.

According to this embodiment, an upper-layer learning model can use a simple method to sequentially switch and operate tasks by the respective learning models of a lower layer.

The invention is not limited to the foregoing embodiments, and various variations/changes are possible within the spirit of the invention

What is claimed is:

1. A robot control apparatus that causes one or more robots to perform a predetermined task formed by a plurality of task processes, comprising:
one or more processors; and
a memory storing instructions which, when the instructions are executed by the one or more processors, cause the robot control apparatus to function as:
first control units each configured to control an operation of the one or more robots for each task process of the plurality of task processes; and
a second control unit configured to specify a combination and an order to execute the first control units in the plurality of task processes and cause each of the first control units to operate in accordance with the combination and the order.

2. The apparatus according to claim 1, the instructions further cause the robot control apparatus to function as:
a third control unit configured to specify a combination and an order to execute a plurality of the second control units in the plurality of task processes and to cause each second control unit to operate in the specified combination and order to execute the second control unit.

3. The apparatus according to claim 1, wherein each of the first control unit and the second control unit is formed by a learning model using reinforcement learning.

4. The apparatus according to claim 3, wherein the second control unit uses, when learning the combination and the order to execute the first control units, the learned first control units that have been learned in advance.

5. The apparatus according to claim 3, wherein the second control unit controls the combination and the order to execute the first control units by outputting, from the learning model using the reinforcement learning, an activation signal which activates each of the plurality of first control units.

6. A robot controlling method that is executed by a robot control apparatus for one or more robots to perform a predetermined task formed by a plurality of task processes, the method comprising:
causing each of first control units to control an operation of the one or more robots for each task process of the plurality of task processes; and
causing a second control unit to specify a combination and an order to execute the first control units in the plurality of task processes and to cause each of the first control units to operate in accordance with the combination and the order.

7. A non-transitory computer-readable storage medium storing a program to cause a computer to function as each unit of a robot control apparatus,
wherein the robot control apparatus is a robot control apparatus which causes one or more robots to perform a predetermined task formed by a plurality of task processes, and comprises
first control units each configured to control an operation of the one or more robots for each task process of the plurality of task processes, and
a second control unit configured to specify a combination and an order to execute the first control units in the plurality of task processes and cause each of the first control units to operate in accordance with the combination and the order.
